(19) United States
(12) Patent Application Publication
(10) Pub. No.: US 2005/0236370 A1
(43) Pub. Date: Oct. 27, 2005

(54) Arc contact element for electrical apparatus production method thereof, corresponding contact assembly and electrical apparatus

(76) Inventors: Jean-Luc Bessede, CHATEAUVILLAIN (FR); Oana Irina Visata, Saint Egreve (FR); Jacques Porte, Lyon (FR)

Correspondence Address: Thelen Reid & Priest, P O Box 640640, San Jose, CA, 95164-0640, US

(21) Appl. No.: 10/520,645

(22) PCT Filed: Jul. 3, 2003
(86) PCT No.: PCT/FR03/02069

§ 371 Date: Jan. 5, 2005

(30) Foreign Application Priority Data
Jul. 5, 2002 (FR) 02/08498

(51) Int. Cl. H01H 33/18

(52) U.S. Cl. 218/43

(57) ABSTRACT

This arcing contact element (10, 18) is capable of occupying an initial position in which it is in contact with another arcing contact element (18, 10), as well as a second position, in which it is separated from this other arcing contact element so as to allow interruption of the current. This element consists of carbon fibres embedded in a matrix which includes at least one electrically conducting material linked to graphite.

The present invention relates to an arcing contact element for electric switch off equipment for medium or high tension, a manufacturing procedure for such an element, a contact assembly including at least one such element, as well as electrical switch off equipment equipped with such a contact assembly.

For the purpose of the invention, electrical switch off equipment for medium or high tension can, for example, be a circuit breaker, a disconnecting switch, a contactor or a charge switch. By medium or high tension is meant tension higher than around 1,000 volts.

As is known such switch off equipment includes a contact assembly equipped with two fixed and mobile parts, each of which is equipped with a contact assembly. The mobile part can thus be moved, in relation to the fixed unit, between a contact position and a separated or switch off position.

During movement of the mobile part between the contact and separated positions, an electric arc is formed which disappears once the arc has been switched off.

The mobile part is also equipped with an insulating nozzle which demarcates an annular channel by which, during movement of the mobile part, an insulating gas is directed to the zone where the electric arc is produced.

FR-A-2 181 699 describes a high tension circuit breaker of the type described above. In this circuit breaker the arcing contact elements are made of graphite bodies enclosing, in their places of contact, an electrically conducting additive made up of one or more metals.

EP-A-0 665 565 has also proposed a contact assembly for switching off equipment which is equipped with an additional part forming a wearing part made of graphite.

This second solution, however, presents disadvantages linked to the insufficient mechanical strength of the material used. So, during mechanical shocks, which particularly occur during closing operations, small graphite particles are likely to become detached from the contact assembly.

This is therefore in a position to disturb the arcing switch off and a reduction in dielectric strength may even occur. In addition, the fragility of the graphite makes the link between this wearing part and the rest of the contact assembly difficult. This also leads to the different constitutive elements costing more and therefore hampers their implementation at the industrial level.

EP-A-O 205 897 also suggested implementing the arcing contact element from carbon fibres embedded in a carbon matrix.

However, this alternative solution also has drawbacks that are particularly inherent in the weak thermal and electrical conductivity of the carbon. This then causes high contact resistance and consequently high temperature rises.

This weak electrical conductivity is also harmful to the proper functioning of the circuit breaker given that there is a risk that the arc will switch over to parallel contacts i.e. permanent current contacts. In addition, in the implementation procedure described in this document, the carbon fibres are included in a graphite matrix, which is complex from an industrial perspective and therefore results in additional manufacturing costs.

Finally, U.S. Pat. No. 5,599,615 describes an electrical component intended to be integrated in electrical equipment which includes an arrangement of non-metallic fibres arranged in a conducting metal matrix. The aforementioned fibres have an axial direction and are parallel to each other. They can be implemented in carbon while appropriate metals to shape the matrix can for example be aluminium or iron as well as noble metals.

Having specified this, the invention aims to offer an arcing contact element which can be implemented simply and easily while possessing improved overall strength compared to the previous technology, particularly on mechanical and electrical planes so as to increase the lifecycle of the switch off equipment equipped with it.

For that purpose its objective is an arcing contact element for electrical switch off equipment for medium and high tension, particularly for circuit breakers, this element being intended to be added to a fixed or mobile support belonging to a contact assembly of this switch off equipment, this unit being capable of occupying in operation an initial position in which it is in contact with another contact assembly as well as a second position in which it is separated from this other contact assembly so as to allow interruption of the current in the equipment, this contact assembly including carbon fibres embedded in a matrix that includes at least one electrically conducting material characterised by the fact that the matrix also includes carbon in the form of graphite.

For the purposes of the invention this electrically conducting material has an electric resistance lower than 200 μΩ.Cm.

Carbon fibres provide good mechanical strength as well as satisfactory resilience to the arcing contact element of the invention. In addition, the latter has satisfactory electrical and thermal conductivity thanks to the aforementioned matrix.

Graphite matrix provides weak friction to the invention's contact assembly. In addition this matrix plays a filling role i.e. it prevents the presence of too large a quantity of conducting material, which would lead to a massive risk of it being vaporised.

This matrix thus enables the conducting material being held within graphite cores. Thus even if this material is in a liquid or vaporised state it is held within these cores so that there is little chance of being pumped out.

It should be noted that operating disconnecting switch contact assemblies can be envisaged by using just conducting material as a matrix connected to a carbon fibre structure.

From this perspective these fibres are arranged according to compact braiding with weak interstices so as to satisfactorily hold the conducting material in the event of fusion with it.

The last application particularly suits disconnecting switches, given that they are subjected to relatively moderate temperature rises, particularly compared to those undergone by circuit breakers.

A positive feature of the invention is that the carbon fibres include long fibres arranged according to three-dimensional braiding.

For the purposes of the invention such long fibres have a ratio between their length and their diameter higher than 100, more likely 1,000 or even more likely 10,000. This measurement makes it possible to improve the mechanical strength of the contact assembly still more while providing a satisfactory homogeneity to the mechanical properties of the arcing contact element.

According to another characteristic of the invention the conducting material represents a weight of between 10 and 50%, preferably between 20 and 40% of the contact assembly.

According to another characteristic of the invention, fibres represent a weight of between 1 and 90%, preferably between 30 and 80% of the arcing contact element.

According to another characteristic of the invention the conducting material is copper. However, silver, nickel, tin or even aluminium, whether pure or alloyed can also be envisaged.

According to another positive characteristic of the invention the diameter of these carbon fibres is between 0.1 and 50 micrometers, preferably between 2 and 15 micrometers.

According to another characteristic of the invention the arcing contact element is roughly composed of carbon fibres and the matrix consisting of at least one conducting material. For the purposes of the invention this means that less than 3% of the contact element consists of any other material.

The purpose of the invention is also to be a manufacturing process of an arcing contact element as defined above, characterised by the fact that it includes the following stages:
An arrangement of carbon fibres is set up
These carbon fibres are impregnated using the matrix with at least one conducting material.

According to a positive characteristic of the invention, the carbon fibres are first partially impregnated with carbon so as to form a primary carbon matrix with inset spaces which are then filled with conducting materials so as to make a secondary matrix formed with this conducting material.

The purpose of the invention is also to be a contact assembly for electrical switch off equipment for medium or high tension, particularly for circuit breakers including a fixed and a mobile contact device, each device being equipped with an arcing contact element, these two contact elements being capable of displaying a first mutual contact position and a second mutual switch off position in which they are separated from each other, characterised by the fact that at least one arcing contact element is as described above.

The purpose of the invention is finally to be electrical switch off equipment for medium and high tension, particularly a circuit breaker consisting of a switch off chamber equipped with a contact assembly characterised by the fact that this contact assembly is as defined above.

The invention will be described below with reference to the appended drawings, which are provided merely as a non-restrictive example in which:

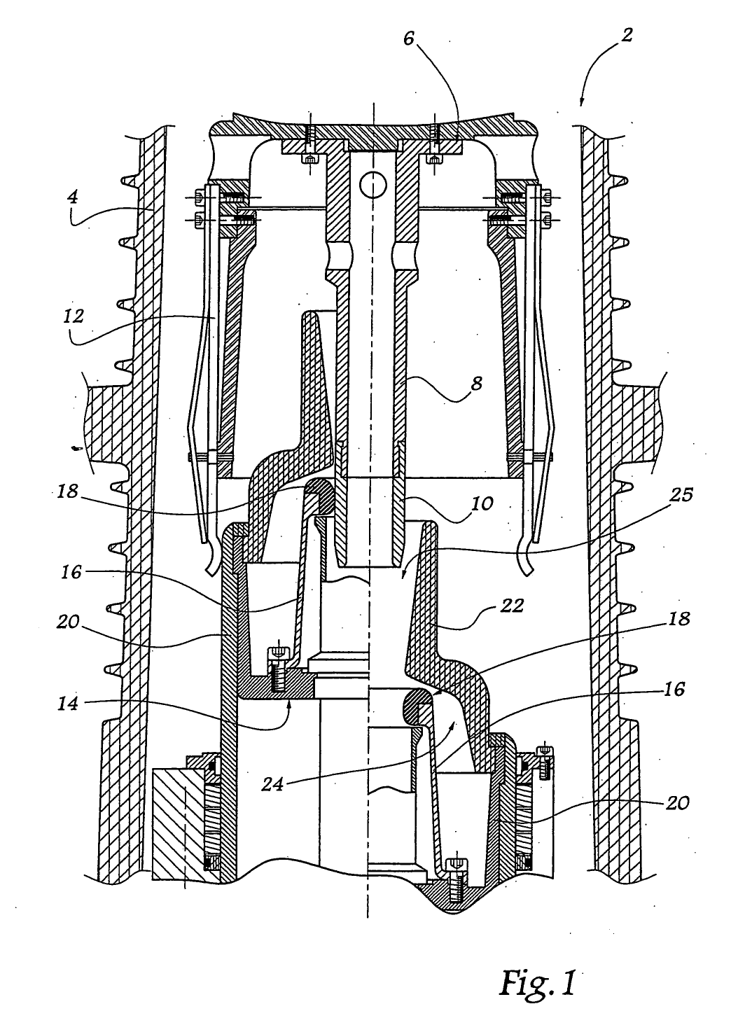

FIG. 1 is a longitudinal section view displaying a switch off chamber belonging to electrical switch off equipment in accordance with the invention

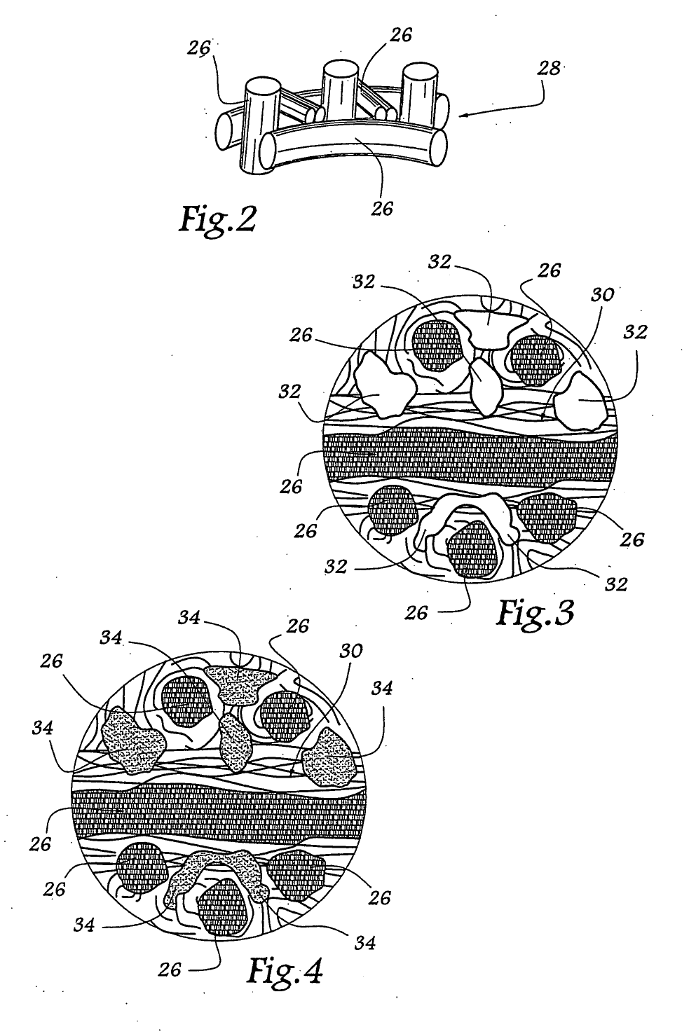

FIG. 2 is a schematic view displaying the first stage of a manufacturing process of an arcing contact element belonging to the switching off equipment of FIG. 1

FIGS. 3 and 4 are micrographic views displaying two subsequent stages of this manufacturing procedure.

FIG. 1 displays a switching off chamber 2 belonging to electrical switching off equipment for medium or high tension, not shown, which can be a circuit breaker for example. This switching off chamber is arranged conventionally so that it will be described succinctly in what follows.

This chamber 2 is demarcated by an insulating cylindrical envelope 4 and is filled with an insulating gas such as SF6 for example. It consists first of all of a fixed contact device allocated in its totality by the reference 6. This device 6, as is well-known, consists of a support 8 on which an arcing contact element is assembled 10.

The link between the support 8 and the contact element is provided for example by any mechanical method such as screwing or pinning or even any welding method with or without filler metal. The contact device 6 which is electrically connected to an electrical socket, not shown, is also equipped with a permanent current contact 12.

The switching off chamber 2 also includes a mobile contact device, designated in its totality by the reference 14. This includes a support 16 on which a mobile contact element 18 is added.

The link between the support 16 and the contact element 18 is provided similarly to the link mentioned above, taking place between the support 8 and the element 10.

This mobile device 14 which is also connected to another electrical socket, not shown, is equipped with a permanent current contact 20. The latter supports an insulating nozzle 22 demarcating an annular channel 24.

During conventional operation the mobile device 14 can be moved between a contact position, shown on the left of FIG. 1 in which elements 10 and 18 are in mutual contact as well as a switching off position, shown on the right of this FIG. 1, in which these two elements 10 and 18 are mutually separated.

When moving the mobile device 14 from its contact position to its switching off position an electric arc is formed between the two contact elements 10 and 18 while an insulating gas is, via the annular channel 24, directed to zone 25 of this electric arc.

FIGS. 2 to 4 show three manufacturing stages of an arcing contact element 10 or 18 equipping the electric equipment whose switching off chamber 2 is shown in FIG. 1.

First of all, as shown in FIG. 2, the carbon fibres 26 must be arranged so as to form three-dimensional braiding designated in its totality by the reference 28.

Such a formation stage of this braiding 28 is known as such from the state of the technology. It is for example described in the work entitled “Practice of industrial materials”, published in May 1998 in the collection “DUNOD reference systems”.

The three-dimensional braiding 28 is carried out from long carbon fibres for the purpose of the invention previously mentioned and it is inevitable that a fair amount of these long fibres will be damaged by breakage or separation of fibres during formation of the braiding. Consequently, the material obtained from braided carbon fibres is composed of long carbon fibres and carbon fibres which are no longer long fibres for the purpose of the invention.

Once the braiding 28 is done, the carbon fibres 26 which compose it must be infiltrated. They are impregnated using carbon in the form of graphite, so as to form a primary matrix 30 stretching primarily around fibres 26.

It should be noted that this impregnation is only partial. Thus the primary matrix 30 defines inset spaces 32 forming free zones which are not filled with carbon.

This second stage described in reference to FIG. 3 is also known as such. Thus it is in particular explained in the above work which was previously mentioned in reference to the FIG. 2 stage.

Finally, as shown in FIG. 4, the braiding 28 and primary matrix 30 must be impregnated with an electrically conducting material like copper. This then occupies the inset spaces 32 which are initially free in the primary matrix 30.

This thus leads to the formation of a secondary matrix 34 composing with the primary matrix 30 a main matrix in which are impregnated the carbon fibres 26.

This third and last stage of the manufacturing procedure of the contact element 10 or 18 is also known as such. It should be noted that during the FIG. 3 stage the primary matrix 30 is formed so that the volume of inset spaces 32 allows the copper matrix 34 to show for example between 20 and 40% of the weight of the contact element considered.

Once the main matrix has been realised the contact element 10 or 18 must be put into shape. This stage, which is not shown, is also implemented in a way that is well-known by any appropriate means of machining, turning, milling or electro-erosion.

1. Arcing contact element (10,18) for electrical switching off equipment for medium and high tension, particularly for circuit breakers, this element being intended to be added to a fixed (8) or mobile (16) support belonging to a contact assembly of this switching off equipment, the said element (10, 18) being capable of occupying during operation an initial position in which it is in contact with another contact element (18,10) as well as a second position in which it is separated from this other contact element so as to allow interruption of the current in the equipment, the said contact element (10,18) including carbon fibres (26) embedded in a matrix (30,34) which includes at least one electrically conducting material characterised by the fact that the said matrix including at least one conducting material also includes carbon in the form of graphite.

2. Element according to claim 1 characterised by the fact that the carbon fibres (26) include long fibres arranged according to three-dimensional braiding (28).

3. Element according to claim 1, characterised by the fact that the conducting material represents a weight of between 10 and 50% of this contact element.

4. Element according to claim 3, characterised by the fact that the conducting material represents a weight of between 20 and 40% of this contact element.

5. Element according to claim 1, characterised by the fact that the size of the particles of the conducting material is between 0.1 and 200 micrometers.

6. Element according to claim 5, characterised by the fact that the size of the particles of the conducting material is between 1 and 50 micrometers.

7. Element according to claim 1, characterised by the fact that the electrically conducting material is copper.

8. Element according to claim 1, characterised by the fact that the diameter of the carbon fibres (26) is between 0.1 and 50 micrometers.

9. Element according to claim 8, characterised by the fact that the diameter of the carbon fibres (26) is between 2 and 15 micrometers.

10. Element according to claim 1, characterised by the fact that it is roughly composed of carbon fibres (26) and the matrix (30, 34), consisting of at least one conducting material.

11. Manufacturing procedure of an arcing contact element (10, 18) in accordance with any of the preceding claims, characterised by the fact that it includes the following stages:
An arrangement (28) of the carbon fibres (16) is formed and
These carbon fibres (26) are impregnated using the matrix (30, 34) including at least one conducting material.

12. Procedure according to claim 11, characterised by the fact that the carbon fibres (26) are first partially impregnated with carbon so as to form a primary carbon matrix (30) with inset spaces (32), then by the fact that these inset spaces are filled with the conducting material so as to realise a secondary material (34) formed of this conducting material.

13. Contact unit for electrical switching off equipment for medium and high tension, particularly for circuit breakers, including a fixed (6) and mobile (14) contact device, each device (6, 14) being equipped with an arcing contact element (10, 18), these two contact elements (10, 18) being capable of presenting a first mutual contact position and a second mutual switching off position in which they are separated from each other, characterised by at least one arcing contact element (10, 18) being capable of occupying during operation an initial position in which it is in contact with another contact element (18,10) as well as a second position in which it is separated from this other contact element so as to allow interruption of the current in the equipment, the said contact element (10,18) including carbon fibres (26) embedded in a matrix (30,34) which includes at least one electrically conducting material characterised by the fact that the said matrix including at least one conducting material also includes carbon in the form of graphite.

14. Electric switching off equipment for medium or high tension, in particular circuit breakers, including a switching off chamber (2) equipped with a contact assembly (10, 18, 22), characterised by the fact that this contact assembly being capable of occupying during operation an initial position in which it is in contact with another contact element (18,10) as well as a second position in which it is separated from this other contact element so as to allow interruption of the current in the equipment, the said contact element (10,18) including carbon fibres (26) embedded in a matrix (30,34) which includes at least one electrically conducting material characterised by the fact that the said matrix including at least one conducting material also includes carbon in the form of graphite.
